(19) United States
(12) Patent Application Publication
(10) Pub. No.: US 2026/0216588 A1
(43) Pub. Date: Jul. 30, 2026

(54) A ROULETTE WHEEL

(71) Applicant: CAMMEGH LIMITED, Bethersden (GB)

(72) Inventor: Richard Cammegh, Bethersden (GB)

(21) Appl. No.: 19/147,567

(22) PCT Filed: Jan. 11, 2024
(86) PCT No.: PCT/GB2024/050067

§ 371 Date: Jul. 11, 2025

(30) Foreign Application Priority Data
Jan. 13, 2023 (GB) 2300550.7

(51) Int. Cl. A63F 5/00; A63F 9/24; G07F 17/32

(52) U.S. Cl. CPC A63F 5/0082; A63F 5/007; G07F 17/3213; G07F 17/3225; A63F 2009/2454; A63F 2009/2492

(57) ABSTRACT

A roulette wheel comprising a base and a rotor which is rotationally coupled to the base such that it rotates relative to the base about a rotational axis, wherein a an electrical power coupling is provided between the base and the rotor; the electrical power coupling is formed by two or more electrically conductive power rings and corresponding electrically conductive power contact elements; the base includes one of the electrically conductive power contact elements and the electrically conductive power rings; the rotor includes the other of the electrically conductive power contact elements and the electrically conductive power rings; each electrically conductive power contact element contacts the respective conductive power ring; the base includes an electrical power source which is electrically connected to the power contact elements or the conductive power rings carried by the base; the rotor defines a plurality of pockets; the rotor carries at least one electrically powered component which is electrically connected to the electrically conductive power contact elements or the electrically conductive power rings carried by the rotor, and is powered via the power coupling; wherein the electrically conductive power rings are arranged concentrically about the rotational axis.

The present invention relates to roulette wheels and, in particular, to roulette wheels which include a power coupling arrangement to transmit power from a base of the roulette wheel to a rotor rotatably coupled to the base.

Roulette wheels have been known for decades. They rely upon a rotor spinning freely relative to a static base. In the game of roulette, the wheel is arranged to spin about a vertical rotational axis. Alternatively, gaming wheels are known in which the rotor is arranged substantially vertically and spins about a rotational axis which is arranged horizontally.

Roulette wheels in which the rotor and an associated turret can be illuminated are also known. In practice, the illumination provided by shining a light through the rotor from a stationary light source, typically located within the base of the wheel. The illumination may be used to provide visual feedback or information to the players.

Also known are roulette wheels in which power is transferred from a base component to a rotor component via an inductive coupling arrangement. Such an arrangement is disclosed in WO2021/185937.

Similarly, it is known to provide power to a rotary component from a stationary base. Such known apparatus typically rely upon a physical connection, such as a slip ring arrangement, to transfer the power from the base to the rotary component. However, such arrangements are not known in connection with roulette wheels, as there are concerns about the introduction of a bias to the rotor part of the roulette wheel

By providing a rotor which is able to receive electrical power from the base, it is possible to locate electronic or electrical components and/or display screens in or on the rotor, which provide a significant increase in what can be displayed to users. For example, parts of the rotor may be illuminated and/or it may display images, such as static images or videos. Similarly, the winning number pocket may be illuminated or otherwise highlighted. Finally, digital serial numbers and calibration data pertaining to the rotor may be stored internally in the rotor, for example in a memory storage component located within the rotor.

Furthermore, visual indications of certain aspects of the game may be displayed by the rotor. For example, a visual indication as to when no more bets may be placed may be displayed by the rotor. It will be appreciated that the rotor is typically the visual focus for a roulette wheels. Accordingly, it is desirable to be able to selectively display information relating to the game on the rotor.

According to a first aspect of the invention, there is provided a roulette wheel comprising a base and a rotor which is rotationally coupled to the base such that it rotates relative to the base about a rotational axis, wherein a an electrical power coupling is provided between the base and the rotor; the electrical power coupling is formed by two or more electrically conductive power rings and corresponding electrically conductive power contact elements; the base carries one of the electrically conductive power contact elements and the electrically conductive power rings; the rotor carries the other of the electrically conductive power contact elements and the electrically conductive power rings; each electrically conductive power contact element contacts the respective conductive power ring; the base includes an electrical power source which is electrically connected to the power contact elements or the conductive power rings carried by the base; the rotor defines a plurality of pockets; the rotor carries at least one electrically powered component which is electrically connected to the electrically conductive power contact elements or the electrically conductive power rings carried by the rotor, and is powered via the power coupling; wherein the electrically conductive power rings are arranged concentrically about the rotational axis.

The skilled person will appreciate that the power coupling is based on a slip ring arrangement.

The invention permits the rotor to carry one or more electrically powered components which may be powered by an electrical power supply in the base via the power coupling.

In the context of the present invention, the “pocket” may be recessed pocket, such as those carried by or defined by a conventional roulette wheel or it may be a defined portion of the rotor component.

In an embodiment of the invention, the base carries the stationary electrically conductive power contact elements (also known as a “brush”) and the rotor carries the rotatable electrically conductive power rings. In such embodiments, the power rings are disposed concentrically with the rotational axis about which the rotor rotates in use. In other words, each of the power rings are spaced from the axis by a different distance. Thus, the power rings rotate with the rotor and a part of each power ring is always contacted by the respective power contact element or brush. In this way, an electrical connection between the base and the rotor is maintained both when the rotor is stationary and when the rotor is rotating about the rotational axis.

The skilled person will appreciate that the opposite configuration is also possible, in which the power rings are stationary components carried by the base and the power contact elements are carried by the rotor. In such embodiments, the power contact elements rotate with the rotor. However, as with the arrangement discussed above, the electrical connection between the base and the rotor is maintained both when the rotor is stationary and when the rotor is rotating about the rotational axis.

By arranging each power ring to be carried by the rotor, the rotational dynamics of the rotor may not be disturbed. As such, no degree of bias may be introduced to the rotor. This is because the weight contribution of each power ring is evenly distributed about the rotational axis of the rotor.

Provided that a frictional force between each power contact element and the respective power ring is substantially constant, the rotor will not be subject to any biasing force that may disturb the random winning selection that results from the rotation of the rotor component, such as the random number selection of a roulette wheel.

Suitably, the electrically powered component carried by the rotor is a light emitter. The light emitter may be energised to illuminate a part of the rotor. For example, each pocket may have associated with it a corresponding light emitter; and each light emitter may be powered via the electrical power coupling. Thus, the rotor may include a number of light emitters which equals the number of pockets defined by the rotor (e.g., in the case of a roulette wheel, 36, 37, 38, 39 or 40 pockets with a corresponding number of light emitters). Each light emitter may be an LED which is capable of illuminating a respective pocket or a part of the rotor associated with a respective pocket. The LEDs may be controlled such that one or more LEDs may be selectively energised. For example, each of the light emitters may be selectively addressable and the roulette wheel may include a controller which is able to control the illumination of one or more of the light emitters. In this way, one or more of the light emitters may be selectively energised and/or illuminated via control signals from the controller.

It should be appreciated that reference herein to the illumination of a pocket includes illumination of a part of the rotor that is associated with a respective pocket. For example, the pocket itself may be illuminated or a portion of the rotor that is radially inwardly or radially outwardly located from the pocket may be illuminated. For example, in conventional roulette wheels, a number ring is typically located radially outwards from a pocket. In such cases, reference to “illumination of a pocket” similar terms herein includes illumination of a portion of the number ring associated with the pocket.

Accordingly, a “winning” pocket may be selectively illuminated by the respective light emitter. Additionally or alternatively, further gaming scenarios may be enabled by the roulette wheel of the subject invention. For example, a pocket may be illuminated while the rotor is rotating. If the illuminated pocket is selected as a winning pocket (e.g., by the roulette ball landing in the pocket), an additional prize may be awarded. Alternatively, if a player places a wager in relation to the illuminated pocket, but this pocket is not selected as a winning pocket, then a “consolation” prize may be won. Such an arrangement allows the roulette wheel to be used in progressive jackpot games and “side bet” games, for example.

In a further embodiment of the invention, the roulette wheel may further include a selector element which randomly selects one of the pockets defined by the rotor, whereupon, the selected pocket is deemed to be a winning pocket. It will be appreciated that in the case of roulette wheels, the selector element is typically a ball which selects a winning pocket by landing in a recess defined by the pocket. Alternatively, the selector element may be a static element which selects a pocket that stops adjacent to the selector element when the rotor ceases rotational movement.

In order to provide an electrical circuit, a positive power coupling and a negative power coupling may be provided between the base and the rotor. Thus, the roulette wheel may include two electrically conductive power contact elements and two corresponding electrically conductive power rings, wherein each electrically conductive power ring has associated with it a corresponding power contact element. The corresponding power contact elements (brushes) may be arranged adjacent to each other, or they may be offset from each other (i.e., arranged in a staggered configuration).

In an embodiment of the invention, each power ring is located within a respective channel defined by or carried by the base or the rotor. In such embodiments, each channel may include a layer of electrically insulating material.

In addition to transmitting power from the base to the rotor, the roulette wheel may further be arranged to transfer data between the base and the rotor. For example, a data coupling may be provided between the base and the rotor; wherein the data coupling is formed by a data ring and a corresponding data contact element; the base includes one of the data contact element and the data ring; the rotor includes the other of the data contact element and the data ring; the data contact element contacts the data ring; the base includes a data signal transmitter and/or receiver which is connected to the data contact element or the data ring carried by the base; the rotor includes a data signal transmitter and/or receiver which is connected to the data contact element or the data ring carried by the rotor; and wherein data is transferred from the base to the rotor and/or from the rotor to the base via the data coupling between the data ring and the data contact element.

It will be appreciated that the data coupling may be the same as the power coupling, wherein data may be transferred via the power coupling; or the data coupling may be separate from the power coupling. Thus, the roulette wheel may include two or more power rings and associated power contact elements; and it may include one or more separate data rings and associated data contact elements. Suitably, the power rings and the or each data ring are arranged concentrically about the rotational axis.

In an embodiment of the invention, the base carries a stationary data contact element and the rotor carries a rotatable data ring.

As with the power coupling, the data coupling may include two or more data rings and associated data contact elements. In such embodiments, the data rings are suitably arranged concentrically about the rotational axis.

In a further embodiment of the invention, the rotor further carries one or more rotatable electrically conductive power rings; wherein the data ring and the power ring(s) are arranged concentrically. Thus, the roulette wheel may include both one or more data ring(s) and two or more power ring(s), which are all suitably be arranged concentrically, i.e., having different radii with respect to the axis of rotation.

The roulette wheel may further include an electrical component controller which controls the or each electrically powered component via control signals transmitted via the data coupling. For example, the electrical component controller may selectively energise and/or control the activation of the or each electrically powered component. In embodiments which include more than one electrically powered component, it may selectively energise and/or control the activation of one or more of the electrically powered components.

Suitably, the electrical component controller is carried by the base.

In an embodiment of the invention, the at least one electrically powered component is a light emitter; each pocket has associated with it a corresponding light emitter; each light emitter is powered via the electrical power coupling; each light emitter is selectively addressable; and wherein each light emitter is selectively controlled via control signals transmitted by the electrical component controller. Thus, the electrical component controller may selectively control the illumination of one or more of the light emitters, which in turn selectively illuminates one or more of the pockets defined by the rotor. In such embodiments, the electrical component controller may be an LED controller.

The roulette wheel suitably further includes one or more sensors which sense which pocket is selected by the selector element (e.g., the roulette ball). Thus, the or each sensor senses a selected pocket. For example, the or each sensor senses a pocket in which the selector ball is disposed when the wheel stops rotating. The or each sensor may be connected to a controller such that the controller sends a control signal to illuminate the selected pocket. The sensor(s) may be carried by the base and/or the rotor. As power is supplied to the rotor from the base, it is possible to locate one or more sensors in the rotor.

The controller to which the or each sensor is connected may be the electrical component controller or it may be a separate controller.

For example, the or each sensor may be connected to a wheel controller which monitors the performance of the wheel and determines certain characteristics associated with the roulette wheel. Accordingly, the wheel controller may sense when the wheel is spinning, when the ball is running around the track above the rotor, when no more bets may be placed, and the pocket in which the ball ends up when the rotor has stopped rotating (the selected or “winning” pocket). The wheel controller is suitably connected to the electrical component controller (e.g., the LED controller) such that the electrical component controller may control the or each electrical component in accordance with a characteristic of the roulette wheel.

The rotor may be a rotor which is manually rotatable relative to the base by a user, such as a croupier, or it may be a powered wheel which is driven to rotate via a motor.

It will be appreciated that a novel roulette wheel may be used in association with the first aspect of the invention. Typical roulette wheels are formed from a metal, such as aluminium to maintain the integrity of the wheel. However, metals are not able to transmit light.

Thus, according to a second aspect of the invention, there is provided a roulette wheel, wherein the roulette wheel includes a body portion formed from a metal, wherein the body portion defines a plurality of apertures; and a translucent polymeric material is secured within each aperture.

In the context of the present invention, the term “translucent” means that the polymeric material is capable of allowing light to pass therethrough. It should be appreciated that translucent materials include within their scope transparent materials. Thus, the term “transparent” is considered to be a sub-set of the term “translucent”.

Suitably, the body portion defines an annular light transmissive region and the annular light transmissive region defines the plurality of apertures. Thus, the plurality of apertures may be arranged annularly about a rotational axis of the roulette wheel. In other words, the apertures may be arranged equally about the rotational axis of the roulette wheel.

In an embodiment of the second aspect of the invention, the annular light transmissive region defines a substantially continuous uniform surface. In such embodiments, the annular light transmissive region may comprise alternating portions of metal roulette wheel body elements and translucent polymeric material. These alternating portions may be machined or otherwise constructed to provide the substantially continuous uniform surface. For example, the continuous uniform surface may be a planar surface or a frustoconical surface.

Suitably, the translucent polymeric material is adhered to portions of the body portion that defines each aperture.

The translucent polymeric material may be in the form of individual separate elements, wherein each element of translucent polymeric material is secured within a respective aperture. Alternatively, the translucent polymeric material may be in the form of an annular ring, wherein the annular ring is secured to the body portion, wherein a portion of the annular ring is associated with each of the apertures defined by the body portion.

The features of the first aspect of the invention may be combined with the features of the second aspect of the invention and vice versa.

The skilled person will appreciate that the features described and defined in connection with the aspects of the invention and the embodiments thereof may be combined in any combination, regardless of whether the specific combination is expressly mentioned herein. Thus, all such combinations are considered to have been made available to the skilled person.

An embodiment of the invention will now be described, by way of example only, with reference to the accompanying drawings in which:

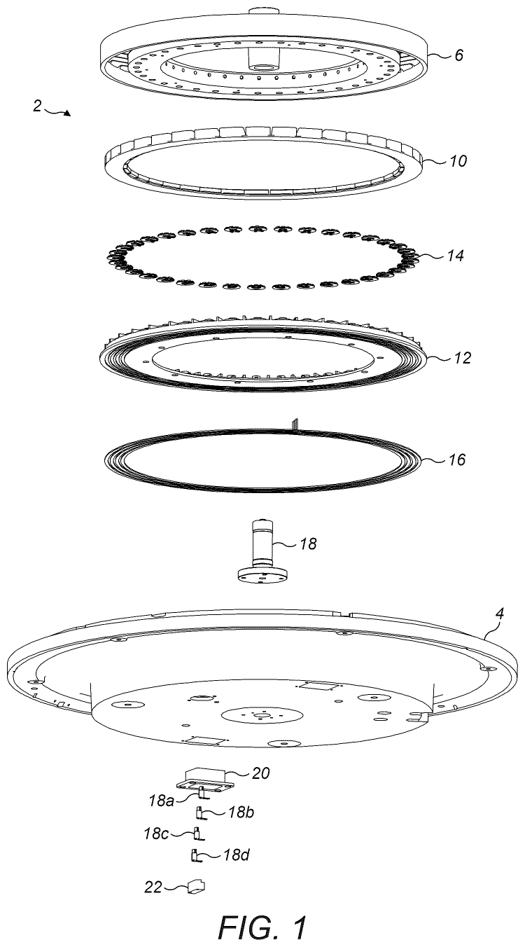

FIG. 1 shows an exploded view of a roulette wheel according to the first aspect of the invention;

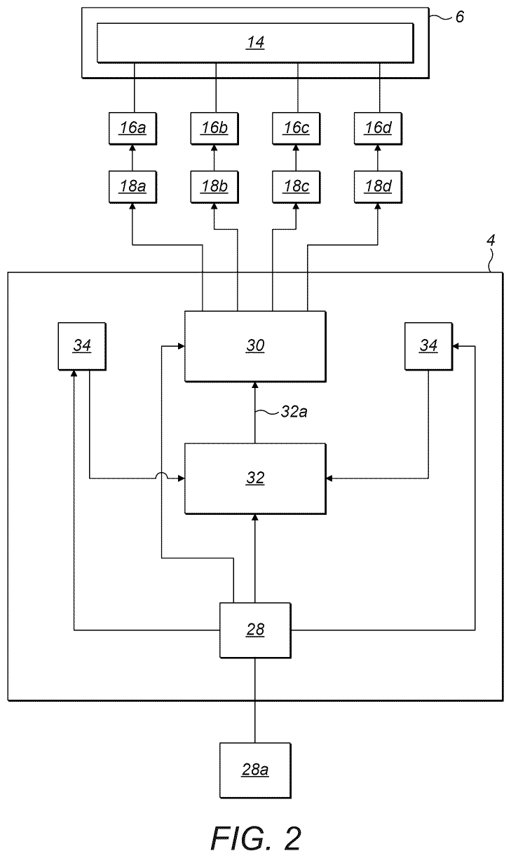

FIG. 2 shows a schematic representation of the first aspect of the invention;

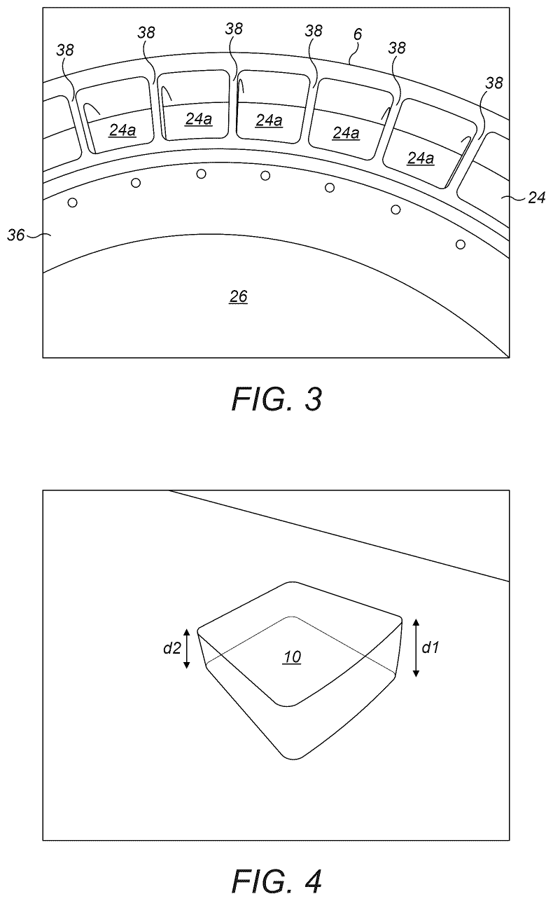

FIG. 3 shows a perspective view of a portion of the roulette wheel body as shown in FIG. 1; and

FIG. 4 shows a perspective view of a translucent polymeric element that forms part of the roulette wheel shown in FIG. 1.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a roulette wheel 2 which comprises a base 4 and a rotor 6 which is rotatably coupled to a spindle 8 that is fixed to the base 4.

The rotor 6 is a conventional roulette wheel rotor in the sense that it defines 37 pockets which are arranged in a circular arrangement that is coaxial with the rotational axis of the wheel. Each pocket has a radially outwardly disposed indicia portion 24 (shown in more detail in FIG. 3) which bears indicia to identify the respective pocket. As is conventional for roulette wheels, the indicia is a number and colour associated with the respective pocket. The indicia portion 24 of the rotor 6 is arranged concentrically around the pockets.

The rotor 6 is formed from an aluminium body 26. The indicia portion 24 of the rotor 6 defines 37 apertures 24a through the aluminium body 26. A circular array of translucent elements 10 is secured to the indicia portion 24 of the rotor 6 such that a translucent element 10 is secured within each of the apertures 24a defined by the indicia portion of the rotor 6.

As shown in FIG. 4, the translucent elements 10 are each wedge-shaped, wherein a height dimension d1 of each of the translucent elements is greater at a radially outward end compared with a height dimension d2 of the element 10 at a radially inward end (i.e., the end adjacent to the respective pocket). It will be appreciated that reference herein to “radially outward” and “radially inward” refers to the elements 10 when disposed with the respective apertures 24a.

The rotor 6 carries on its downwardly facing surface (i.e., the surface which in use faces the base) a slip ring carrier 12. The slip ring carrier 12 has secured to it on an upwardly facing surface a circular array of 37 light emitting diodes (LEDs) 14. Each of the LEDs 14 within the array are individually addressable. In this arrangement, the array of LEDs 14 is sandwiched between the slip ring carrier 12 and the translucent elements 10.

On the downwardly facing surface of the slip ring carrier 12 is defined four circular channels which are arranged coaxially about an axis of rotation that is defined by the spindle 8, such that the four channels are concentrically arranged about the axis of rotation.

Located within each of the channels is a respective electrical power ring 16c, 16d or a data ring 16a, 16b. The outer two of the rings 16 are electrical power rings, providing a positive 16c and negative 16d electrical power source; and the inner two of the rings 16a, 16b are data rings, wherein data rings 16a, 16b transmit data to and from the LEDs 14. The data rings 16a, 16b are connected to an LED controller 30 carried by the base 4.

Each of the rings 16a-d is contacted by a respective contact element 18a-d. The contact elements 18a-d are located within a contact element housing 20 which in turn is coupled to the base 4. The contact elements 18a-d are retained within the contact element housing 20 by a retainer 22.

Two of the contact elements 18c, 18d are connected via the LED controller 30 to an electrical power supply 28 (shown schematically in FIG. 2) within the base 4, which in turn is connected to a mains power supply 28a. The other two of the contact elements 18a, 18b are also connected to the LED controller 30 (shown schematically in FIG. 2), which in turn is connected to a wheel processor 32 that as also carried by the base 4.

In use, electrical power from the electrical power supply 28 in the base 4 is transmitted to the rotor 6 via the engagement of the power contact elements 18c, 18d with the respective electrical power rings 16c, 16d. The arrangement means that power may be transferred to the rotor 6 even when the rotor 6 is rotating relative to the base 4.

The electrical power transmitted to the rotor 6 is distributed to the individually addressable LEDs 14. This permits selected LEDs 14 to be energised, whereupon they emit visible light.

In addition to electrical power from the electrical power source 28, the LED controller 30 in the base 4 also transmits control signals to specific ones of the individually addressable LEDs 14. The control signals instruct each LED to be in either an illuminated mode or a non-illuminated mode. The control signals from the LED controller 30 to each of the LEDs 14 are transmitted from the LED controller 30 to the LEDs 14 carried by the rotor 6 via a data coupling formed by the data rings 16a, 16b and the respective data contact elements 18a, 18b.

As shown in FIG. 2, the base 4 further includes the wheel processor 32 which receives data from a number of wheel sensors 34. The wheel processor 32 processes data from the wheel sensors 34 to determine the status of the roulette wheel 2 at all times. Such wheel processors and wheel sensors are known. Thus, the wheel processor 32 determines when a roulette ball is moving relative to the rotor 6, determines when no more bets may be placed from the speed and position of the ball relative to the rotor 6, and determines in which pocket the ball has landed when the rotor 6 has stopped rotating relative to the base 4.

In the present embodiment, the sensors 34 are shown as being carried by the base 4. However, as power is transmitted to the rotor 6 from the base 4, it is possible to locate one or more sensors 34 in or on the rotor 6, wherein sensor(s) 34 carried by the rotor 6 may be powered by the electrical power that is transmitted to the rotor 6 via the power coupling 16c, 16d, 18c, 18d.

The wheel processor 32 includes an output 32a which is connected to the LED controller 30. The LED controller 30 transmits a control signal which illuminates all of the LEDs at a time when no more bets may be placed as determined by the wheel processor 32. As the wheel slows, the LED controller transmits a second control signal to place all of the LEDs in a non-illuminated condition. When the ball finally lands in a pocket, the wheel processor 32 determines the identity of the pocket from the wheel sensors 34. This status information is transmitted to the LED controller 30, which in turn transmits a third control signal via the data coupling to illuminate the LED associated with the winning pocket. In other words, the LED 14 located beneath the indicia portion 24 associated with the winning pocket is controlled to illuminate by the LED controller 30.

Additionally or alternatively, the indicia portion associated with a random pocket may be illuminated by the LED controller 30 when the rotor 6 is rotating, and this pocket may be associated with a separate winning event.

As shown in FIG. 2, the power source 28 further provides electrical power to the wheel sensors 34, the LED controller 30 and the wheel processor 32.

FIG. 3 shows a portion of the aluminium body 26 of the rotor 6. As noted above, the aluminium body 26 is formed from an aluminium rotor blank. The rotor blank has machined into it the circular indicia portion 24 and a pocket-receiving portion 36 disposed radially inwards from the circular indicia portion 24, wherein both the pocket-receiving portion 36 and the indicia portion 24 are coaxial with the centre of the rotor 6 (i.e., the axis of rotation of the rotor 6). 37 apertures 24a are then machined through the indicia portion 24, wherein each of the apertures 24a are separated by a web 38 of the body 26.

The translucent polymeric wedge-shaped elements 10 (shown in FIG. 4) are then adhered within respective ones of the apertures 24a defined by the indicia portion 24 of the body 26.

In order to maintain the non-biased nature of the rotor 6, the aluminium body 26 is then machined for a further time to provide a continuous and uniform surface on the indicia portion 24 of the body 26. This surface is a smooth frustoconical surface. An annular printed indicia sheet of polymeric material is then adhered to the smooth frustoconical surface of the indica portion. Again, the rotor 6 is machined to ensure that no bias is introduced to the rotor 6 by the printed indicia sheet.

Finally, an annular array of pockets (not shown) is secured to the pocket-receiving portion 36 of the rotor body 26.

The arrangement of the printed indicia sheet disposed upon the translucent polymeric element 10 within the indicia portion 24 and the individually addressable LED located beneath the translucent polymeric element 10 results in a rotor wherein a portion of the indicia portion 24 of the rotor 6 associated with a specific pocket may be illuminated.

The skilled person will appreciate that in addition to the translucent elements 10 disposed within the indicia portion 24, or as an alternative to the translucent elements 10 disposed within the indicia portion 24, the pocket-receiving portion 36 of the rotor 6 may include a circular array of translucent polymeric elements, wherein each pocket itself may be selectively illuminated.

1. A roulette wheel comprising a base and a rotor which is rotationally coupled to the base such that it rotates relative to the base about a rotational axis, wherein a an electrical power coupling is provided between the base and the rotor; the electrical power coupling is formed by two or more electrically conductive power rings and corresponding electrically conductive power contact elements; the base carries one of the electrically conductive power contact elements and the electrically conductive power rings; the rotor carries the other of the electrically conductive power contact elements and the electrically conductive power rings; each electrically conductive power contact element contacts the respective conductive power ring; the base includes an electrical power source which is electrically connected to the power contact elements or the conductive power rings carried by the base; the rotor defines a plurality of pockets; the rotor carries at least one electrically powered component which is electrically connected to the electrically conductive power contact elements or the electrically conductive power rings carried by the rotor, and is powered via the power coupling; and wherein the electrically conductive power rings are arranged concentrically about the rotational axis.

2. A roulette wheel according to claim 1, wherein the base carries the electrically conductive power contact elements and the rotor carries the concentric electrically conductive power rings.

3. A roulette wheel according to claim 1, wherein the at least one electrically powered component is a light emitter.

4. A roulette wheel according to claim 3, wherein each pocket has associated with it a corresponding light emitter; and wherein each light emitter is powered via the electrical power coupling.

5. A roulette wheel according to claim 1, wherein a data coupling is provided between the base and the rotor; wherein the data coupling is formed by a data ring and a corresponding data contact element; the base includes one of the data contact element and the data ring; the rotor includes the other of the data contact element and the data ring; the data contact element contacts the data ring; the base includes at least one of a data signal transmitter and a receiver which is connected to the data contact element or the data ring carried by the base; and wherein data is transferred from the base to the rotor and/or from the rotor to the base via the data coupling between the data ring and the data contact element.

6. A roulette wheel according to claim 5, wherein the base carries a stationary data contact element and the rotor carries a rotatable data ring.

7. A roulette wheel according to claim 6, wherein the rotor further carries two or more electrically conductive power rings; and wherein the data ring and the power rings are arranged concentrically about the rotational axis.

8. A roulette wheel according to claim 5, wherein the roulette wheel further includes a controller which controls the or each electrically powered component via control signals transmitted via the data coupling.

9. A roulette wheel according to claim 8, wherein the controller is carried by the base.

10. A roulette wheel according to claim 8, wherein the at least one electrically powered component is a light emitter; each pocket has associated with it a corresponding light emitter; each light emitter is powered via the electrical power coupling; each light emitter is selectively addressable; and wherein each light emitter is selectively controlled via control signals transmitted by the controller.

11. A roulette wheel according to claim 1, wherein the rotor is driven to rotate via a motor.

12. A roulette wheel according to claim 1, wherein the rotor includes a body portion formed from a metal; wherein the body portion defines a plurality of apertures; and wherein a translucent polymeric material is secured within each aperture.

13. A roulette wheel according to claim 12, wherein the apertures are arranged annularly about the rotational axis of the rotor.

14. A roulette wheel according to claim 12, wherein each aperture is associated with a respective pocket defined by the rotor.

15. A roulette wheel according to claim 12, wherein each aperture has associated with it a respective light emitter; wherein the light emitters are selectively powered via the power coupling.
